(19) United States
(12) Patent Application Publication
(10) Pub. No.: US 2014/0214525 A1
(43) Pub. Date: Jul. 31, 2014

(54) DETERMINING PROPER PRESENTATION OF MULTIMEDIA CONTENT

(71) Applicants: Arthur Tsai, Taipei City (TW); William Su, Taipei (TW)

(72) Inventors: Arthur Tsai, Taipei City (TW); William Su, Taipei (TW)

(21) Appl. No.: 13/995,573

(22) PCT Filed: Dec. 13, 2011
(86) PCT No.: PCT/US11/64577

§ 371 Date: Mar. 11, 2014

(51) Int. Cl. G06Q 30/02

(52) U.S. Cl. CPC G06Q 30/0242
USPC 705/14.41

(57) ABSTRACT

Systems and methods of determining proper presentation of a multimedia content may include a remote management module configured to enable managing a remote computer system. This may include having a local view of a multimedia content being displayed on a display of the remote computer system. The multimedia content may have been previously encoded. The system may also include a capturing module coupled to the remote management module and configured to capture the local view of the multimedia content, and a decoding module coupled to the capturing module and configured to decode the captured local view of the multimedia content to retrieve encoding information from the captured local view of the multimedia content.

### BACKGROUND

1. Technical Field

Embodiments generally relate to remote monitoring and diagnostic. More particularly, embodiments relate to detecting that a multimedia is properly presented.

2. Discussion

Advertisers who use digital signage to broadcast advertisements may be interested in knowing that their advertisements are presented in manners such that the advertisements get the most exposure to viewers. Unfortunately, various (problems may occur during the broadcast of the advertisements. For example, data may be corrupted, or the scheduling of the broadcast may be incorrect. The problems may cause the advertisements to be disrupted. For example, one or more scenes in a video advertisement may be distorted; a frame may be accidentally skipped;

some frames may be presented out-of-order. Often the problems may last for a period of time before they are recognized and reported to a technical support team. As a result, the advertisements may not be effective between a time when the problems actually occur and a time when the problems are corrected.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1A is a block diagram that illustrates an example system that may be used to locally verify a proper presentation of a multimedia, in accordance with some embodiments;

FIG. 1B is a block diagram that illustrates an example system that may be used to remotely verify a proper presentation of a multimedia, in accordance with some embodiments;

FIG. 2 is a block diagram that illustrates an example encoding system, in accordance with some embodiments;

FIG. 3 is a block diagram that illustrates an example player system, in accordance with some embodiments;

FIG. 4 is a block diagram that illustrates an example management system, in accordance with some embodiments;

FIG. 5A is a block diagram that illustrates one example implementation of a player system and a management system, in accordance with some embodiments;

FIG. 5B is a block diagram that illustrates one example application of the Advanced Management Technology (AMT) features and the remote keyboard video mouse (KVM) features, in accordance with some embodiments;

FIGS. 6A and 6B illustrate an example frame and pixels that may be used to insert the encoding information, in accordance with some embodiments;

FIG. 7A is a flowchart of an example method of locally verifying proper presentation of an encoded multimedia content, in accordance with some embodiments;

FIG. 7B is a flow chart of an example method of remotely verifying proper presentation of an encoded multimedia content, in accordance with some embodiments; to FIG. 8 is a block diagram showing an example computer system that may be used to implement an encoding system, a player system, or a management system, in accordance with some embodiments.

### DETAILED DESCRIPTION

Embodiments may involve a system which may include a presentation module configured to receive a multimedia content and present the multimedia content on a display. The multimedia content may have been previously encoded. A capturing module may be coupled to the presentation module and May be configured to capture the multimedia content that is presented on the display. A decoding module may be coupled to the capturing module and may be configured to decode the captured multimedia content to retrieve encoding information from the captured multimedia content. A comparison module may be coupled to the decoding module and may be configured to compare the encoding information with stored information. An alert module may be coupled to the comparison module and may be configured to generate an alert based on the encoding information not being consistent with the stored information.

Embodiments may involve a system which may include a remote management module configured to enable managing a remote computer system. The remote management may include having a local view of a multimedia content being displayed on a display of the remote computer system. The multimedia content may be previously encoded. A capturing module may be coupled to the remote management module and may be configured to capture the local view of the multimedia content. A decoding module may be coupled to the capturing module and may be configured to decode the captured local view of the multimedia content to retrieve encoding information from the captured local view of the multimedia content. A comparison module may be coupled to the decoding module and may be configured to compare the encoding information with stored information. An alert module may be coupled to the comparison module and may be configured to generate an alert based on the encoding information not being consistent with the stored information.

Embodiments may involve a computer implemented method which may include presenting a multimedia content on a display. The multimedia content may be previously encoded. The method may also include capturing the multimedia content that is presented on the display, decoding the captured multimedia content to retrieve encoding information from the captured multimedia content, and comparing the encoding information with stored information to determine whether the multimedia content is properly presented on the display. Further, the method may include generating an alert based on the multimedia content not being properly presented on the display. The captured multimedia content includes multiple frames, and the encoding information is different or unique for each of the multiple frames.

Embodiments may involve a computer implemented method which may include using remote management capability to manage a remote computer system. The remote management capability may enable having a local view of a multimedia content being displayed on a display of the remote computer system. The multimedia content may have previously been encoded.

The method may also include capturing the local view of the multimedia content, decoding the captured local view of the multimedia content to retrieve encoding information from the captured local view of the multimedia content, and generating an alert based on the encoding information not being consistent with stored information. The remote management capability may be used to enable controlling keyboard, video and mouse (KVM) operations of the remote computer system based on the remote computer system configured to allow for remotely controlling of its KVM operations.

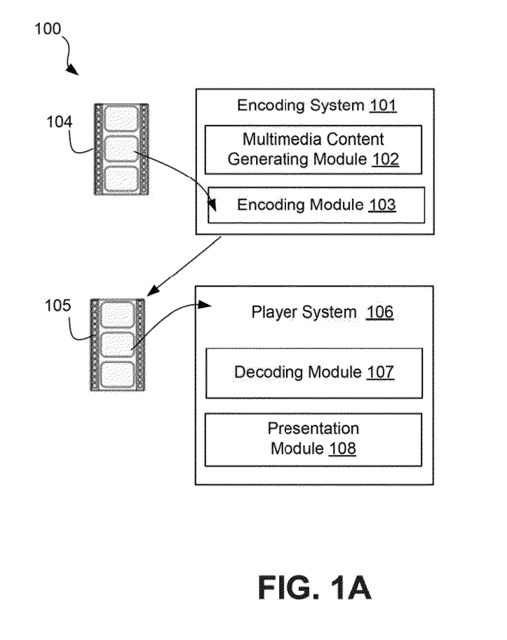

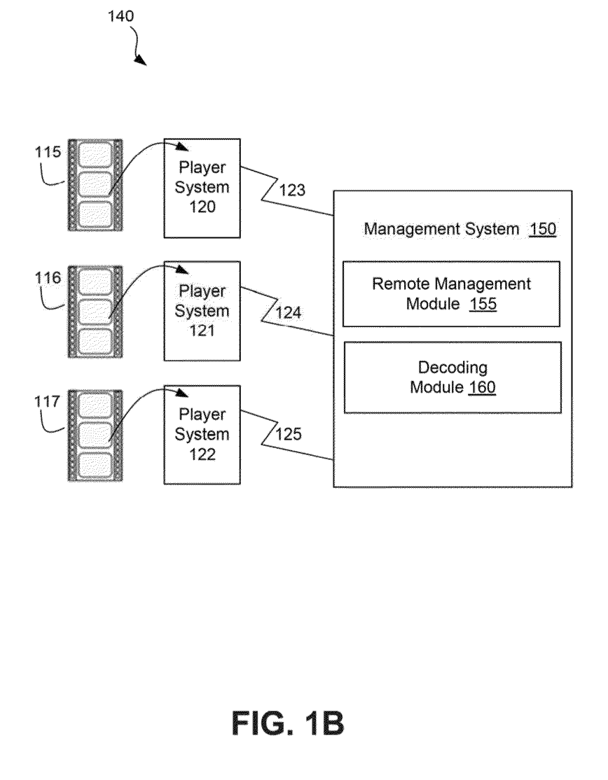

Turning to FIG. 1A, a block diagram 100 of an example system to locally verify a proper presentation of a multimedia content may be shown. The proper presentation may also be referred to as “proof of play” or proof that the multimedia content is played with all of the frames presented in a correct sequence. The diagram 100 may include an encoding system 101, which may be configured to encode a multimedia content 104 (e.g., a video, an advertisement, or other multimedia content) to generate an encoded multimedia content 105. The diagram 100 may also include a player system 106 which may be configured to present or play the encoded multimedia content 105. For example, the player system 106 may be a digital signage computer system, and the encoded multimedia content may be an encoded version of an advertisement to be presented to the viewers. For example, the player system 106 may display television programming, menus, advertisements and other messages. The encoded multimedia content may be a video such as, for example, an advertising video or a movie trailer.

The encoding system 101 may include a multimedia generating module 102 configured to enable a user to generate or create the multimedia content 104, and an encoding module 103 configured to enable encoding the multimedia content 104. It may be possible that the multimedia content 104 may have been generated by another computer system and received by the encoding system 101. An advertising company may use the encoding system 101 to generate an advertisement, encode the advertisement, and provide the encoded advertisement to a digital signage player (e.g., the player system 106). The digital signage player may then present the encoded advertisement to the viewers.

For some embodiments, the encoding information used to encode the multimedia content 104 may not be visible to the viewers. For example, the encoding information may be in the form of a digital watermark. For some embodiments, the encoding information may be used to verify whether the encoded multimedia content 105 is properly presented by the player system 106. The player system 106 may include a presentation module 108 to present the encoded multimedia content 105, and a decoding module 107 to decode the encoded multimedia content 105. The decoding operations may include retrieving the encoding information from the encoded multimedia content 105. The decoding module 107 may decode the encoded multimedia content 105 at approximately the same time the encoded multimedia content 105 is presented by the presentation module 108. It may be possible that the decoding module 107 may decode the encoded multimedia content 105 after the encoded multimedia content 105 is presented by the presentation module 108.

Turning to FIG. 1B, a block diagram 140 of an example system to remotely verify a proper presentation of a multimedia content is shown. The diagram 140 may include a management system 150, which may be configured to remotely manage one or more player systems 120, 121 and 122 by way of respective communication channels 123, 124 and 125. Each of the player systems 120, 121 and 122 may be configured to present a respective encoded multimedia content 115, 116 and 117. The presentation of the encoded multimedia content 115, 116 and 117 may be captured by the remote management module 155 of the management system 150 and via the respective communication channels 123, 124 and 125. The management system 150 may include a decoding module 160 configured to decode the encoded multimedia content 115, 116 and 117 captured by the remote management module 155. It may be noted that one or more of the player systems 120, 121 and 122 may be configured to include its own decoding module (e.g., decoding module 107 of FIG. 1A) to be able to perform the decoding of the respective encoded multimedia content 120, 121 and 122 locally.

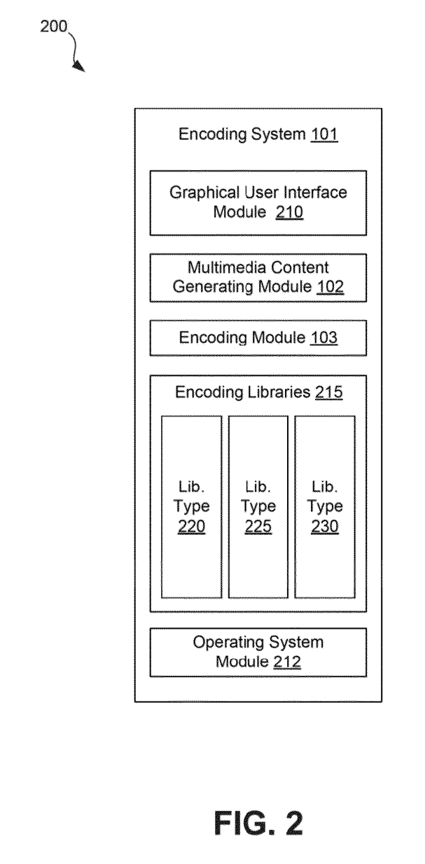

Turning to FIG. 2, a block diagram 200 of an example encoding system 101 is shown. The encoding system 101 may include the multimedia generating module 102 and the encoding module 103 as described with respect to FIG. 1A. The encoding system 101 may also include a graphical user interface 210 configured to enable a user to interact with the encoding module 103 to determine how the multimedia content 104 may be encoded. The encoding module 103 may be associated with encoding libraries 215 which may include different library types 220, 225 and 230. For example, the library types may be AVI (Audio Video Interleave) a multimedia container format introduced by Microsoft in November 1992 as part of its Video for Windows technology, MPEG-4 (Moving Picture Experts Group 4)—a standard for a group of audio and video coding formats and related technology agreed upon by the ISO/IEC Moving Picture Experts Group (MPEG) (ISO/IEC JTC1/SC29/WG11) under the formal standard ISO/IEC 14496. The encoding system 101 may also include an operating system module 212 which may be, for example, Windows 7 Operating System from Microsoft Corporation of Redmond, Wash.

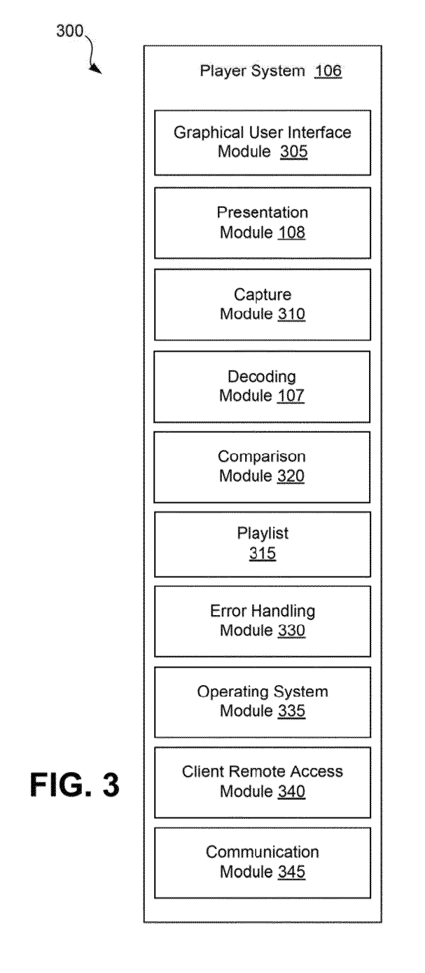

Turning to FIG. 3, a block diagram 300 of an example player system 106 is shown. The player system 106 may include the decoding module 107 and the presentation module 108 as described with respect to FIG. 1A. The player system 106 may also include a graphical user interface 305 configured to enable a user to interact with one or more modules included in the player system 106. For example, the graphical user interface 305 may include a selection option to enable the user to select an encoded multimedia content 105 to be presented by the presentation module 108. For some embodiments, the presentation of the encoded multimedia content 105 may be automatic, based on a predetermined schedule, manually activated by a user or any combinations thereof.

The player system 106 may include a capture module 310, a comparison module 320, a playlist 315 and an error handling module 330. The capture module 310 may be configured to capture the encoded multimedia content 105 that is presented by the presentation module 108. For example, the capture module 310 may capture every frame associated with the encoded multimedia content 105. The decoding module 107 may then decode these frames and extract the coding information from the frames. The comparison module 320 may compare the extracted coding information with the playlist 315. It should be noted that the playlist 315 may correspond to previously stored information which may have been provided by an entity associated with the multimedia content. The previously stored information may be stored as a list, or it may be stored in any data structure that may enable it to be quickly retrieved. The playlist 315 may store a sequence of frame identifications according to how those frames should be presented to the viewers. This stored sequence of frame identifications may be used for comparison by the comparison module 320 to determine whether the frames associated with the encoded multimedia content 105 are properly presented and viewed by the viewers. For some embodiments, the operations of the capture module 310, the decoding module 107, and the comparison module 320 may be performed periodically. It may be noted that the player system 106 may enable reviewing images that have been captured to verify what was played.

The error handling module 330 may be configured to report potential errors when the frames of the encoded multimedia content 105 are not properly presented. For example, some of the frames may be presented out of order while some other frames may be completely missing. The player system 106 may also include an operating module 335 which may be, for example. Windows 7 Operating System from Microsoft Corporation of Redmond, Washington.

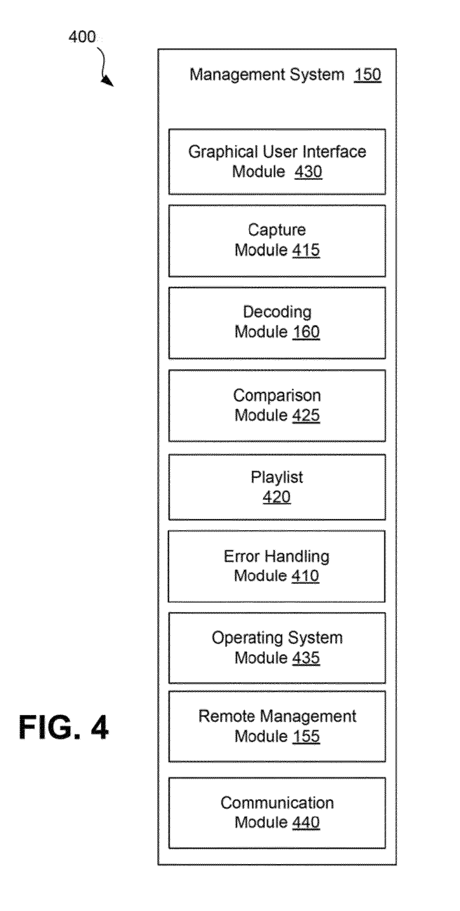

For some embodiments, the player system 106 may include a client remote access module 340 configured to enable information presented on a display of the player system 106 to be captured by a management system 150 (described in FIG. 4). The player system 106 may also include a communication module 345 configured to enable the player system 106 to be connected to a network (e.g., local area network, wide area network). It may be noted that the client remote access module 340 may be necessary when the decoding of the encoded multimedia content 105 is performed from a management system 150 (described in FIG. 4).

Turning to FIG. 4, a block diagram 400 of an example management system 150 is shown. The management system 150 may include the decoding module 160 and the remote management module 155 as described with respect to FIG. 1B. The management system 150 may be coupled to the player system 106 and may include a graphical user interface module 430 and a capture module 415. The graphical user interface module 430 may be configured to enable a user to interact with one or more modules included in the management system 150. For example, the graphical user interface module 430 may include a selection option to enable a user to initiate the process of capturing encoded multimedia content such as the encoded multimedia content 105 (FIG. 1A) when it is presented in the player system 106 (FIG. 3). The capture module 415 may be configured to capture every frame associated with the encoded multimedia content. For some embodiments, the capturing operations of the capture module 415 may be automatic, manually activated by a user or any combinations thereof. For some embodiments, the operations of the capture module 415 may be performed periodically.

The management system 150 may also include a comparison module 425, a playlist 420 and an error handling module 410. Based on the capture module 415 capturing the frames of the encoded multimedia content, the decoding module 160 may then examine these frames and extract the coding information from the frames. The comparison module 425 may compare the extracted coding information with previously stored information in the playlist 420. The playlist 420 may store a sequence of frame identifications according to how those frames should be presented to the viewers. The error handling module 410 may be configured to report potential errors when the frames of the encoded multimedia content may not be properly presented (e.g., out of order frames, missing frames, etc.), The management system 150 may also include an operating module 435 which may be, for example, Windows 7 Operating System from Microsoft Corporation of Redmond, Wash.

For some embodiments, the management system 150 may include are/note management module 155 configured to enable information presented at the player system to be captured by capture module 415. The remote management module 155 may be coupled to the client remote access module 340 of the player system. The management system 150 may also include a communication module 440 configured to enable the management system 150 to be connected to a network. It may be noted that the functions of two or more modules included in each of the diagrams shown in FIG. 2-FIG. 4 may be combined.

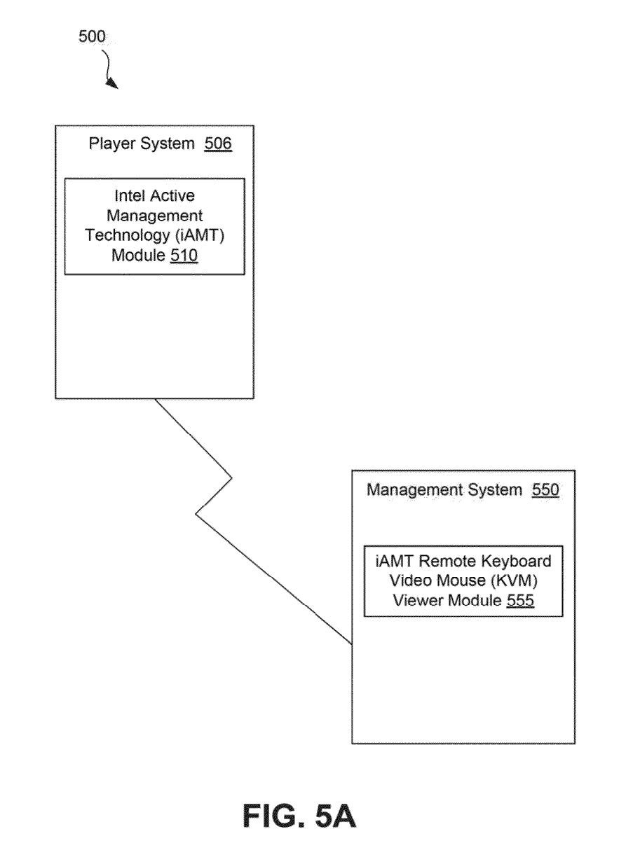

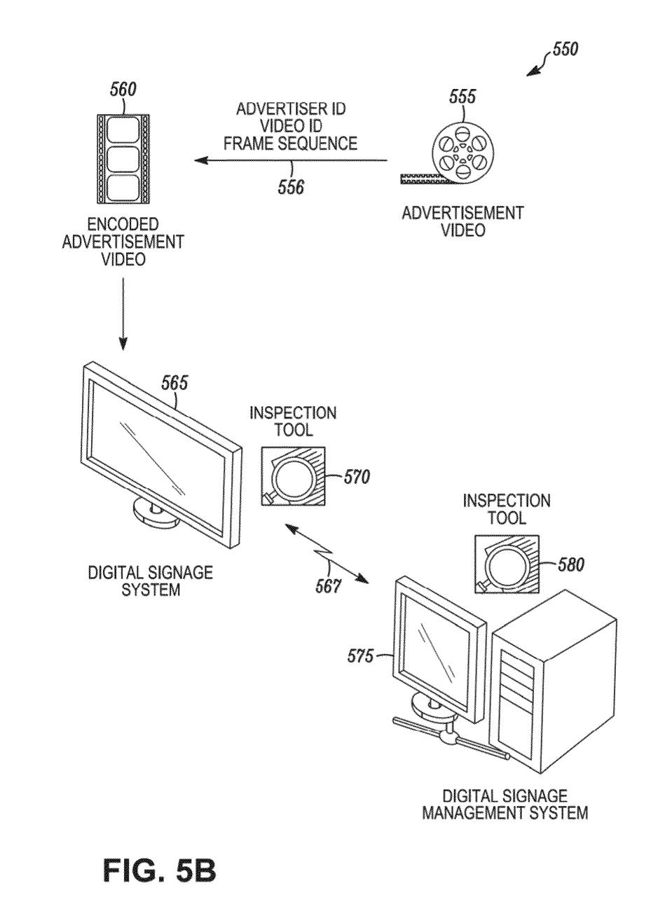

Turning to FIG. 5A, a block diagram 500 of one example implementation of a player system and a management system is shown. For some embodiments, the player system 506 may be configured to include an active management technology (AMT) module 510 which may be based on, for example, an Intel Active Management Technology (iAMT) platform from Intel Corporation of Santa Clara, Calif. The AMT module 510 may correspond to the client remote access module 340 (described in FIG. 3).

The AMT module 510 may be a silicon-resident management mechanism for remote discovery, healing, and protection of the player system 506. The AMT module 510 may provide a basis for remote management of the player system 506 including operating-system (OS) failures, hardware failures, etc. The AMT module 510 may enable storing hardware asset information in flash memory that can be read anytime, even when the player system 506 may be powered off, or when the OS of the player system 506 does not function as expected.

The AMT module 510 may provide management applications with a general-purpose, non-volatile data store that accepts local or network-based storage commands. The AMT module 510 may enable proactive alert notification to notify system problem, even when the system may be down. The AMT module 510 may provide out-of-band (OOB) access to remotely diagnose, control, and repair the player system 506 after software, OS, or hardware failures. The AMT module 510 may include alerting and event logging features that may assist diagnosing problems quickly to reduce downtime. The AMT module 510 may also support IDE-Redirection and

Serial-Over-IAN capabilities for management applications.

For some embodiments, the management system 550 may be configured to include a remote Keyboard Video Mouse (KVM) module 555 which may be configured to operate with the AMT module 510 of the player system 506. For example, the KVM module 555 may be an Intel remote KVM product from Intel Corporation of Santa Clara, Calif. The remote KVM module 555 may be configured to enable control of a platform such as, for example, the player system 506, remotely using a remote keyboard and mouse. The remote KVM module 555 may include features that support digital signage applications that have high-resolution graphics. The remote KVM module 555 may have a console open a session with the AMT module 510 and control the player system 506 using a mouse and a keyboard at the management system 550. A user may use the console to have a local view what is displayed on a display associated with the player system 506. When a user at the management system 550 uses a console and initiates a KVM session with the AMT module 510, a user at the player system 506 may have to agree to this remote KVM control before the session may start. Turning to FIG. 5B, a block diagram 550 of one example application of the AMI' features and the remote KVM features is shown. The example application may be related to displaying advertisements using a digital signage computer system 565. The advertisement may originally be a non-encoded advertisement video 555, which may then be encoded with advertiser ID, video ID and frame sequence information 556 to become encoded advertisement video 560. The encoded advertisement video 560 may then be displayed on the digital signage system 565. The digital signage system 565 may include an inspection tool 570 to enable locally verifying if the encoded advertisement video 560 is properly presented. The inspection tool 570 may be associated with the capture module 310, the decoding module 107 and the comparison module 320 described in FIG. 3. In an alternative configuration, the display of the encoded advertisement video 560 at the digital signage system 565 may be captured on a console of the digital signage management system 575. An inspection tool 580 of the digital signage management system 575 may then be used to verify whether the encoded advertisement video 560 is properly presented. The inspection tool 580 may be associated with the capture module 415, the decoding module 160 and the comparison module 425 described in FIG. 4. The inspection tools 570 and 580 may retrieve the encoding information from the encoded advertisement video 560. For some embodiments, the coding information may include video identification (VD), frame identification (FID), and identification of an advertiser associated with the encoded advertisement video 560. The digital signage system 565 may be communicatively connected to the digital signage management system 575 via a connection 567, wherein the connection 567 may be coupled to a local area network, a wide area network such as the Internet, or a combination of both.

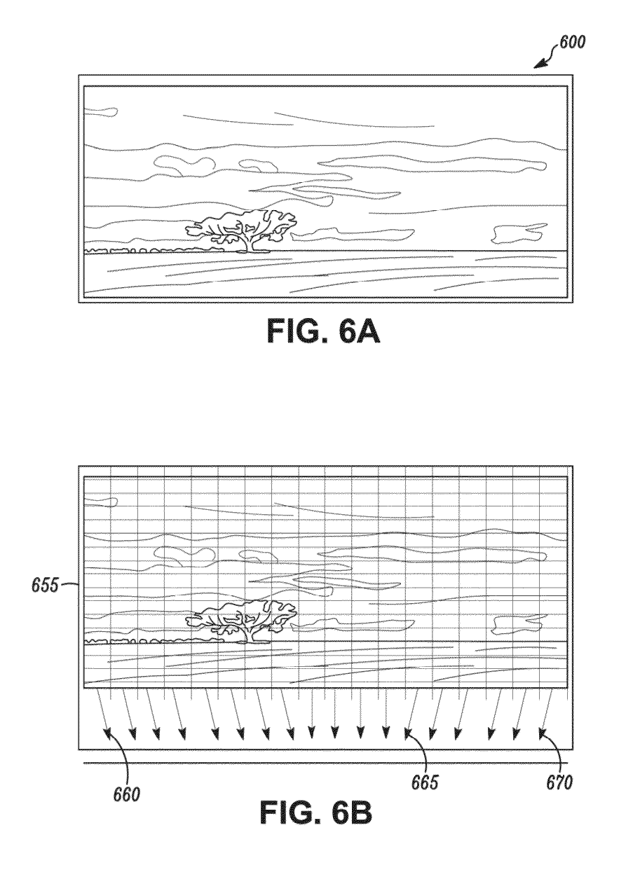

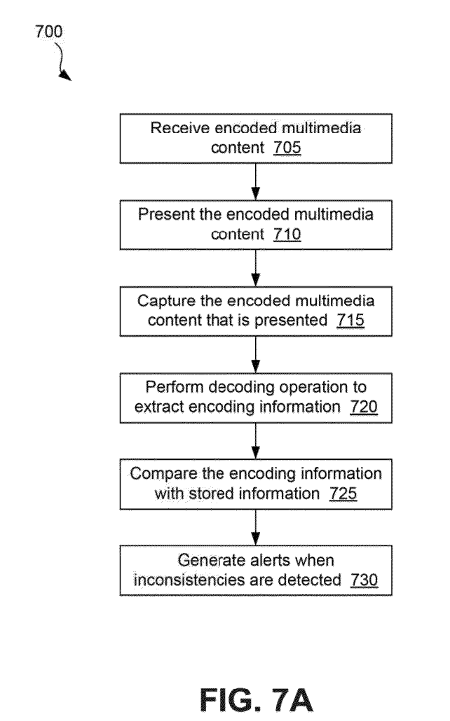

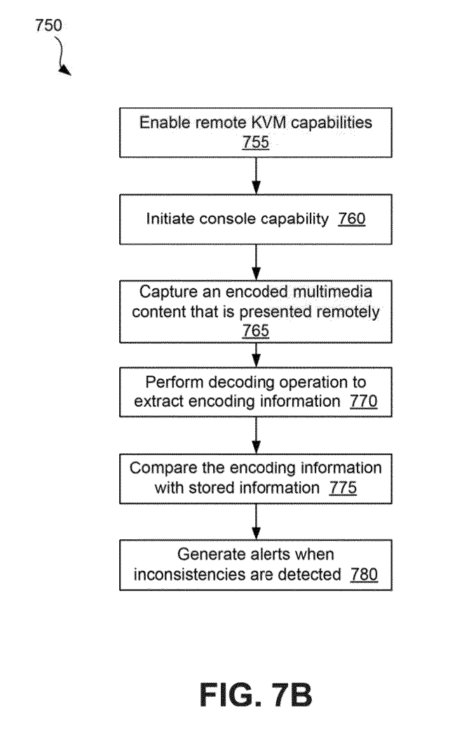

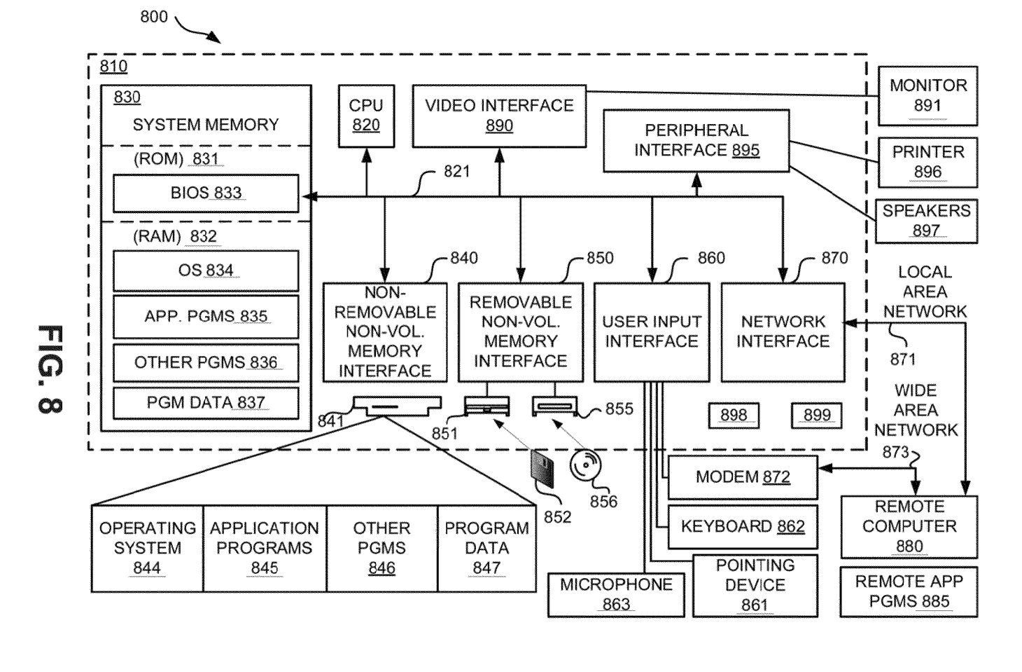

Turning to FIG. 6A, an example frame 600 is shown. The frame 600 may be one of many frames associated multimedia content such as an advertisement. The frame 600 may include multiple pixels. For illustrative purposes, the pixels may be represented as rectangular boxes shown in FIG. 6B. For some embodiments, the encoding information may be stored in a pixel that is least visible to a viewer and/or one that may not significantly affect the quality of the frame. For example, the pixels 660 and 670 located at the bottom and corner of the frame 600 may be selected. The pixel 655 located on the left edge of the frame 600 may also be selected. The encoding information may include a frame sequence number, the advertiser ID and the video Turning now to FIG. 7A, a method 700 of locally verifying proper presentation of an encoded multimedia content is shown. The method 700 may be performed by a player system such as the player system 106 of FIG. 3 or the digital signage system 565 of FIG. 5B. At block 705, the encoded multimedia content may be received, For example, the encoded multimedia content may be an advertisement received from an advertiser. At block 710, the encoded multimedia content may be presented. For example, the advertisement may be displayed on a digital signage system 565. At block 715, the encoded multimedia content that is presented may be captured. At block 720, decoding operations may be performed on the captured multimedia content to extract the encoding information. At block 725, the encoding information may be compared with stored information. The stored information may include information that indicates a how the frames of the encoded multimedia content should be presented, If the encoding information of multiple captured frames is consistent with the stored information, then the encoded multimedia content may be properly presented. Otherwise, alerts may be generated, as shown in block 730.

Turning to FIG. 7B, a method 750 of remotely verifying proper presentation of an encoded multimedia content is shown. The method 750 may be performed by a management system such as the management system 150 of FIG. 4 or the digital signage management system 575 of FIG. 5B. The method 750 may start at block 755, where the remote KVM capabilities in the management system 150 may be enabled. As described above, the remote KVM capabilities may enable having a console at the management system 150 to view an encoded multimedia content presented at a player system 106. At block 760, the console capability may be initiated. The player system 106 may need to include an AMT module. A session between the management system 150 (e.g., via its remote KVM capabilities) and the player system 106 (e.g., via its AMT module) may need to be established. At block 765, the encoded multimedia content that is presented at the player system 106 may be captured and displayed in the console of the management system 150. At block 770, using the information in the console, the decoding operations may be performed to extract the encoding information. At block 775, the encoding information may be compared with stored information. The stored information may include information that indicates a how the frames of the encoded multimedia content should be presented. If the encoding information of multiple captured frames is consistent with the stored information, then the encoded multimedia content may be properly presented. Otherwise, alerts may be generated, as shown in block 780.

The methods 700 and 750 may be implemented as a set of logic instructions stored in a machine- or computer-readable storage medium such as RAM, ROM, PROM, flash memory, etc., in configurable logic such as PLAs, FPGAs, CPLDs, in fixed-functionality logic hardware using circuit technology such as ASIC, CMOS or TTL technology, or any combination thereof. For example, computer program code to carry out operations shown in the method may be written in any combination of one or more programming languages, including an object oriented programming language such as C++ or the like and conventional procedural programming languages, such as the “C” programming language or similar programming languages.

Turning to FIG. 8, a block diagram 800 of a computer system 810 and other example peripherals and input/output devices are shown. The computer system 810 may be configured to operate as a mobile computer system, a desktop computer system, a server computer system, or any other computer systems that may be able to perform operations associated with the example diagrams shown in FIG. 1A-FIG. 7B.

The computer system 810 may include, but is not limited to, a processing unit (or CPU) 820 having one or more processing cores, a system memory 830, and a system bus 821 that couples various system components including the system memory 830 to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

The computer system 810 may include a variety of computer readable media. Computer readable media can be any available media that can be accessed by computer system 810 and includes both volatile and nonvolatile media, removable and non-removable media. By way of example, and not limitation, computer readable media may store information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer system 810. Communication media typically embodies computer readable instructions, data structures, or program modules.

The system memory 830 may include computer storage media in the form of volatile and/or nonvolatile memory such as read only memory (ROM) 831 and random access memory (RAM) 832. A basic input/output system (BIOS) 833, containing the basic routines that help to transfer information between elements within computer system 810, such as during start-up, may be stored in ROM 831. The RAM 832 may contain data and/or program modules that are immediately accessible to and/or presently being operated on by processing unit 820. By way of example, and not limitation, FIG. 8 illustrates operating system 834, application programs 835, other program modules 836, and program data 837.

The computer system 810 may also include other removable/non-removable volatile/nonvolatile computer storage media. By way of example only, FIG. 8 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 841 may be connected to the system bus 821 through a non-removable memory interface such as interface 840, and magnetic disk drive 851 and optical disk drive 855 may be connected to the system bus 821 by a removable memory interface, such as interface 850.

The drives and their associated computer storage media discussed above and illustrated in FIG. 8 may provide storage of computer readable instructions, data structures, program modules and other data for the computer system 810. In FIG. 8, for example, the hard disk drive 841 is illustrated as storing operating system 844, application programs 845, other program modules 846, and program data 847. Note that these components can either be the same as or different from operating system 834, application programs 835, other program modules 836, and program data 837. The operating system 844, the application programs 845, the other program modules 846, and the program data 847 are given different numeric identification here to illustrate that, at a minimum, they may be different copies.

A user may enter commands and information into the computer system 810 through input devices such as a keyboard 862, a microphone 863, and a pointing device 861, such as a mouse, trackball or touch pad or touch screen. Other input devices (not shown) may include a joystick, game pad, scanner, or the like. These and other input devices may be connected to the processing unit 820 through a user input interface 860 that may be coupled to the system bus 821, but may be connected by other interface and bus structures, such as a parallel port, game port or a universal serial bus (USB). A monitor 891 or other type of display device may be connected to the system bus 8211 via an interface, such as a video interface 890. In addition to the monitor, the computer system 810 may also include other peripheral output devices such as speakers 897 and printer 896, which may he connected through an output peripheral interface 895.

The computer system 810 may operate in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer system 810. The logical connections depicted in FIG. 8 may include a local area network (LAN) 871 and a wide area network (WAN) 873, but may also include other networks. Such networking environments are commonplace in offices, enterprise-wide computer networks, intranets and the Internet. When used in a LAN networking environment, the computer system 810 may be connected to the LAN 871 through a network interface or adapter 870. When used in a WAN networking environment, the computer system 810 may include a modem 872 or other means for establishing communications over the WAN 873, such as the Internet. The modem 872, which may be internal or external, may be connected to the system bus 821 via the user-input interface 860, or other appropriate mechanism. In a networked environment, program modules depicted relative to the computer system 810, or portions thereof, may be stored in a remote memory storage device. By way of example, and not limitation, FIG. 8 illustrates remote application programs 885 as residing on remote computer 880. It will be appreciated that the network connections shown are exemplary and other means of establishing a communications link between the computers may be used.

It should be noted that some embodiments of the present invention may be carried out on a computer system such as that described with respect to FIG. 8. However, some embodiments of the present invention may be carried out on a server, a computer devoted to message handling, handheld devices, or on a distributed system in which different portions of the present design may be carried out on different parts of the distributed computing system.

Another device that may be coupled to the system bus 821 is a power supply 898 such as a battery or a Direct Current (DC) power supply) and Alternating Current (AC) adapter circuit. The DC power supply may be a battery, a fuel cell, or similar DC power source needs to be recharged on a periodic basis. A clock generator 899 may also be used to provide clock, signals. The communication module for modern) 872 may employ a Wireless Application Protocol (WAP) to establish a wireless communication channel. The communication module 872 may implement a wireless networking standard such as Institute of Electrical and Electronics Engineers (WEE) 802.11 standard, IEEE std. 802.11-1999, published by IEEE in 1999.

Embodiments of the present invention may be applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) arc set forth in order to describe example embodiments of the invention, it should be apparent to one skilled in the art that embodiments of the invention can be practiced without, or with variation of these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. might be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A system comprising:
logic to receive previously encoded multimedia content and present the multimedia content on a display;
logic to capture the multimedia content that is presented on the display; and
logic to decode the captured multimedia content and to retrieve encoding information from the captured multimedia content.

2. The system of claim 1, further comprising:
logic to compare the encoding information with stored information; and
logic to generate an alert based on the encoding information not being consistent with the stored information.

3. The system of claim 1, wherein the captured multimedia content includes multiple frames, and wherein the encoding information is different for each of the multiple frames.

4. The system of claim 3, wherein the encoding information includes frame identification.

5. The system of claim 4, wherein the stored information includes information about a sequence of frames of the multimedia content based on their frame identification.

6. The system of claim 5, wherein the logic to compare is configured to compare the frame identification of the frames associated with the captured multimedia content to the information about the sequence of frames of the multimedia content.

7. The system of claim 6, wherein the logic to generate the alert is configured to generate the alert based on the frame identification of the frames associated with the captured multimedia content not being consistent with the information about the sequence of frames of the multimedia.

8. The system of claim 7, wherein the encoding information is stored in a pixel of a frame of the multimedia content, and wherein the encoding information is not visible to a viewer of the multimedia content on the display.

9. The system of claim 8, wherein the multimedia content is an advertisement, wherein the display is a digital signage, and wherein the encoding information includes an identification of the advertisement and an identification of an advertiser associated with the advertisement.

10. A system comprising:
logic to manage a remote computer system including having a local view of a previously encoded multimedia content presented on a display of the remote computer system;
logic to capture the local view of the multimedia content; and
logic to decode the captured local view of the multimedia content to retrieve encoding information from the captured local view of the multimedia content.

11. The system of claim 10, further comprising:
logic to compare the encoding information with stored information; and
logic to generate an alert based on the encoding information not being consistent with the stored information.

12. The system of claim 11, wherein the captured multimedia content includes multiple frames, and wherein the encoding information is unique for each of the multiple frames.

13. The system of claim 12, wherein the encoding information includes frame identification, and wherein the stored information includes information about a sequence of frames of the multimedia content based on their frame identification.

14. The system of claim 13, wherein the logic to compare the encoding information with the stored information includes logic to compare the frame identification of the frames associated with the captured local view of the multimedia content to the information about the sequence of frames of the multimedia content

15. The system of claim 14, wherein the logic to manage the remote computer system includes logic to control keyboard, video and mouse (KVM) operations of the remote computer system.

16. The system of claim 15, wherein the logic to manage the remote computer system includes logic to communicate with a silicon-resident management logic in the remote computer system.

17. The system of claim 16, wherein the multimedia content is an advertisement, wherein the display is a digital signage, wherein the encoding information includes an identification of the advertisement and an identification of an advertiser associated with the advertisement, and wherein the encoding information is not visible to a viewer of the advertisement on the digital signage,

18. A method comprising:
presenting a previously encoded multimedia on a display;
capturing the multimedia content that is presented on the display;
decoding the captured multimedia content to retrieve encoding information from the captured multimedia content; and
comparing the encoding information with stored information to determine whether the multimedia content is properly presented on the display.

19. The method of claim 18, further comprising generating an alert based on the multimedia content not being properly presented on the display, wherein the captured multimedia content includes multiple frames, and wherein the encoding information is different for each of the multiple frames.

20. The method of claim 19, wherein the encoding information includes frame identification, wherein the stored information includes information about a sequence of frames of the multimedia content based on their frame identification, and wherein the frame identification of the frames associated with the captured multimedia content is compared to the information about the sequence of frames of the multimedia content to determine whether the multimedia content is properly presented on the display.

21. A computer-implemented method comprising:
using remote management capability to manage a remote computer system including having a local view of a previously encoded multimedia content presented on a display of the remote computer system;
capturing the local view of the multimedia content;
decoding the captured local view of the multimedia content to retrieve encoding information from the captured local view of the multimedia content; and
generating an alert based on the encoding information not being consistent with stored information.

22. The method of claim 21, wherein the remote management capability is to enable controlling keyboard, video and mouse (KVM) operations of the remote computer system.

23. The method of claim 22, wherein the remote management capability is to enable initiating a KVM session with the remote computer system via a silicon-resident management logic of the remote computer system.

24. The method of claim 23, wherein the captured local view of the multimedia content includes multiple frames, and wherein the encoding information is unique for each of these multiple frames.

25. The method of claim 24, wherein the encoding information includes frame identification, wherein the stored information includes information about a sequence of frames of the multimedia content based on their frame identification, and wherein the frame identification of the frames associated with the captured local view of the multimedia content is compared to the information about the sequence of frames of the multimedia content to determine whether to generate the alert.
